(19) United States
(12) Patent Application Publication
(10) Pub. No.: US 2008/0216793 A1
(43) Pub. Date: Sep. 11, 2008

(54) Engine

(76) Inventor: Albert Henry Bow, Milperra (AU)

Correspondence Address: KNOBBE MARTENS OLSON & BEAR LLP, 2040 MAIN STREET, FOURTEENTH FLOOR, IRVINE, CA, 92614, US

(21) Appl. No.: 11/606,778

(22) Filed: Nov. 30, 2006

Related U.S. Application Data
(63) Continuation-in-part of application No. PCT/AU2005/000770, filed on Jun. 1, 2005.

(30) Foreign Application Priority Data
Jun. 1, 2004 (AU) 2004902890

(51) Int. Cl. F02B 47/02

(52) U.S. Cl. 123/25 E

(57) ABSTRACT

A method for use in controllably generating mechanical power from a piston engine without combusting fuel, wherein the piston engine includes:
a piston;
a cylinder having an upper chamber and a lower chamber separated by a partition, the partition including an opening and a partition valve located adjacent the opening, the partition valve being adjustable between an opened and a closed position, wherein when the valve is arranged in the opened position, fluid communication via the opening is enabled between the upper and lower chambers, and when the partition valve is arranged in the closed position, fluid communication between the upper and lower chambers via the opening is substantially restricted;
the piston being slidably engagable within the cylinder between a lower end of the cylinder and the partition so as to be able to vary a volume of the lower chamber between a relative minimum volume, and, a relative maximum volume;
the upper chamber being bounded by the partition and a gasket disposed on an upper end of the cylinder;
a first supply means adapted for supplying air in to at least one of the upper and lower chambers; and
a second supply means adapted for supplying at least one of water vapor and Hydrogen in to the lower chamber;
the method including the steps of:
(i) supplying air into at least one of the upper and lower chambers via the first supply means;
(ii) thereafter, compressing the air into the upper chamber so as to form heated air, and closing the partition valve so as to temporarily store the heated air within the upper chamber;
(iii) thereafter, supplying at least one of water vapor and Hydrogen into the lower chamber via the second supply means;
(iv) thereafter, opening the partition valve when the lower chamber is at a relative minimum volume wherein, the heated air disposed in the upper chamber is released into the lower chamber via the opened partition valve, and the water vapor and/or Hydrogen in the lower chamber is caused to expand upon interaction with the heated air so as to force outward movement of the piston from the cylinder, whereby the lower chamber is adjusted from the relative minimum volume into the relative maximum volume.

### CROSS-REFERENCE TO RELATED APPLICATIONS

This application is a continuation-in-part of International Application PCT/AU2005/000770, entitled An Engine, and filed on Jun. 1, 2005.

### BACKGROUND OF THE INVENTION

1. Field

The present invention relates to engines and in particular, engines which utilize water or steam.

2. Description of the Related Art

Prior art engines generate mechanical energy from heat energy. For instance, in a typical motor vehicle, petrol is combusted in a cylinder and piston arrangement in order to provide mechanical energy. A problem with such engines is that they require relatively expensive fossil fuels such as petrol or diesel to operate. The waste products produced by combusting petrol or diesel also tends to be harmful to both humans and the environment.

Attempts have been made to address the problems associated with prior art combustion engines which use fossil fuels. For instance, PCT Application No, PCT/AU2005/000770 (Publication No. WO2005/119015) describes an environmentally-friendly prior art piston engine which is powered by the controlled expansion and contraction of water vapor. The prior art invention described therein uses a piston to rapidly compress air into a receptacle located at the top of a cylinder chamber during an upstroke cycle in order to raise the temperature of the air to around 500 degrees centigrade. The heated air in the receptacle is later released so that it can interact with water vapor and/or Hydrogen which has been subsequently supplied into the cylinder so that a controlled expansion of the water vapor and Hydrogen may take place.

However, whilst the prior art invention seeks to address at least one of the above-described problems associated with prior art combustions engines, it does exhibit certain deficiencies. For instance, the piston-cylinder arrangement of the prior art invention tends to be inefficient when compressing the air into the receptacle and therefore the amount of power that can be effectively harnessed from the engine may not be maximized.

A further problem associated with both the prior art invention described in PCT/AU2005/000770 and certain prior art engines generally, is that it is often time-consuming and tedious to perform maintenance on the engine.

For instance, where a valve within the piston engine is in need of repair or cleaning, it may be necessary to dismantle the engine in order to access the valve which may be disposed within the cylinder chamber.

### SUMMARY OF THE INVENTION

The present invention seeks to alleviate at least one of the problems described above in relation to the prior art.

The present invention involves several different broad forms. Embodiments of the invention may include one or any combination of the different broad forms herein described.

In a first broad form, the present invention provides a method for use in controllably generating mechanical power from a piston engine without combusting fuel, wherein the piston engine includes:

a piston;

a cylinder having an upper chamber and a lower chamber separated by a partition, the partition including an opening and a partition valve located adjacent the opening, the partition valve being adjustable between an opened and a closed position, wherein when the valve is arranged in the opened position, fluid communication via the opening is enabled between the upper and lower chambers, and when the partition valve is arranged in the closed position, fluid communication between the upper and lower chambers via the opening is substantially restricted;

the piston being slidably engagable within the cylinder between a lower end of the cylinder and the partition so as to be able to vary a volume of the lower chamber between a relative minimum volume, and, a relative maximum volume;

the upper chamber being bounded by the partition and a gasket disposed on an upper end of the cylinder;

a first supply means adapted for supplying air in to at least one of the upper and lower chambers; and

a second supply means adapted for supplying at least one of water vapor and Hydrogen in to the lower chamber;

the method including the steps of:

(i) supplying air into at least one of the upper and lower chambers via the first supply means;

(ii) thereafter, compressing the air into the upper chamber so as to form heated air, and closing the partition valve so as to temporarily store the heated air within the upper chamber;

(iii) thereafter, supplying at least one of water vapor and Hydrogen into the lower chamber via the second supply means;

(iv) thereafter, opening the partition valve when the lower chamber is at a relative minimum volume wherein, the heated air disposed in the upper chamber is released into the lower chamber via the opened partition valve, and the water vapor and/or Hydrogen in the lower chamber is caused to expand upon interaction with the heated air so as to force outward movement of the piston from the cylinder, whereby the lower chamber is adjusted from the relative minimum volume into the relative maximum volume.

Typically, in use, a connecting rod may extend from the piston, the connecting rod being operably connected to a crankshaft via a cam profile. Typically, inward and outward movement of the piston relative to the lower chamber of the cylinder may cause the cam profile to rotate. Typically, following step (iv) described in accordance with the first broad form of the present invention, rotational motion of the cam profile and momentum of the piston may cause the piston to be cyclically re-directed inwardly of the lower chamber once again in a second upstroke. Thereafter, when the piston has retracted into the lower chamber such that the lower chamber attains the relative minimum volume, the steps (i)-(iv) may be repeated once again.

Preferably, in step (i), the following sub-steps may be performed:

(a) the first supply means may be opened;

(b) the partition valve may be opened; and

(c) a first downstroke of the piston relative to the lower chamber may be commenced wherein the volume of the lower chamber is adjusted from the relative minimum volume into the relative maximum volume, wherein air is drawn into the upper and lower chambers via the opened first supply means.

Typically, sub-steps (a) and (b) may occur at the same time, though it may be preferable for sub-step (b) to follow almost immediately after sub-step (a) or vice versa. Typically, sub-step (c) may occur almost instantaneously after sub-steps (a) and (b) have been effected.

Typically, the first downstroke of the piston relative to the lower chamber may be initiated manually—for instance, a user may turn the cam profile so as to commence outward movement of the piston from the lower chamber.

Preferably, in step (ii) of the first broad form, the following sub-steps may be performed:

(a) the first supply means may be closed;

(b) a first upstroke of the piston relative to the lower chamber may be effected wherein the lower chamber is adjusted into the relative minimum volume from the relative maximum volume, wherein the air in the upper and/or lower chambers may be forcibly compressed into the upper chamber so as to generate heated air for later release into the lower chamber; and

(c) the partition valve may be closed when the lower chamber has been adjusted into the relative minimum volume so that heated air compressed into the upper chamber may be temporarily withheld from entering the lower chamber.

Typically, step (iii) may occur almost instantaneously after the piston is commencing a second downstroke—the second downstroke being commenced as a result of momentum of the piston being directed out of the cylinder due to the interaction with the cam profile. Typically, step (iv) of the first broad form occurs almost instantaneously after step (iii) of the first broad form has been effected. That is, the partition valve may be opened almost instantaneously after at least one of water vapor and Hydrogen has been supplied into the lower chamber. Typically, about 3 cubic centimeters of water may be used to fill every one liter vacuum of the lower chamber as the piston is moving through its second downstroke. In certain embodiments, the partition valve may be opened approximately 10 milliseconds after at least one of the water vapor and Hydrogen have been supplied into the lower chamber.

Preferably, the partition valve may include:

a mounting member adapted for coupling the partition valve to the cylinder;

an elongate portion having a first end attached to the mounting member, and, a second end attached to a valve seal, the elongate portion being adjustably extendable and retractable relative to the mounting member. Preferably, when the elongate member is extended relative to the mounting member the valve seal is positioned to cover the partition opening so as to restrict fluid communication between the upper and lower chambers, and, when the elongate portion is retracted relative to the mounting member, the valve seal is positioned such that it does not cover the partition opening so that fluid communication is enabled between the upper and lower chambers via the partition opening.

Typically, a recess may be disposed in the partition adjacent the partition opening such that when the valve seal is positioned to cover the partition opening, the valve seal may be adapted for relatively-snug fitting engagement within the recess.

Typically, the mounting member of the partition valve may be attached to the gasket such that the elongate portion extends inwardly of the upper chamber towards the partition. Typically, the mounting member may be received within an aperture in the gasket. Typically, the aperture includes a cylindrically-shaped aperture. Also typically, the aperture may pass right through the gasket. Preferably, the mounting member may be adapted for screw-threaded engagement with the aperture. Typically, the partition valve may be able to be screwed into place within the aperture from outside of the piston engine without requiring a user to dismantle the piston engine—for instance, without requiring the removal of the gasket. Advantageously, this may assist in improving the ease of access for cleaning or repair of the partition valve given that it may be relatively easily dislodged from the aperture and pulled outwardly away from the cylinder.

Preferably, the partition valve may be electrically actuated—that is, electrical control signals may be used to trigger adjustment of the partition valve between its closed position and its opened position. Typically, an electronic valve controller may be used to generate and provide control signals to the partition valve to trigger adjustments of the partition valve. The controller may be user programmable, or, may be pre-programmed for instance at the point of manufacture. A microprocessor device may be used as the electronic controller for the partition valve. Typically, the electronic controller may be housed within the mounting member. Control signals may be communicated from the controller to the partition valve via a wired or wireless communication link.

It would be appreciated by a person skilled in the art that the partition valve need not necessarily be arranged in accordance with the configuration described above, and, need not be mounted to the gasket. Instead, the partition valve may be adapted for mounting directly on to the partition adjacent to the partition opening.

Typically, the partition may include a thickness of around 10 mm. However it would be appreciated by a person skilled in the art that this thickness may be variable depending upon the specific dimensions of the piston engine being used. Typically, the partition may be made from metal.

Preferably, the first supply means includes a first inlet valve and a first conduit adapted to allow air to be channeled to the first inlet valve for release into the upper chamber from an air supply source which may typically be external to the upper chamber. Typically, the first inlet valve may be attached to the gasket whereby it may allow for air to be supplied into the upper chamber of the cylinder.

Preferably the air that is supplied into the upper chamber via the first supply means may include substantially water-free air.

Preferably, the first inlet valve includes a controller adapted to control the opening and closing of the first inlet valve. Typically, the controller may include an electronic controller and more typically, the partition controller may also serve as the controller for the first inlet valve.

Preferably, the second supply means includes a second inlet valve and a second conduit adapted to allow water and/or Hydrogen to be channeled to the second inlet valve for release into the lower chamber from a water and/or Hydrogen supply source which may typically be external to the lower chamber. Typically, the second supply means may be at least partially housed within the partition.

Typically, the second inlet valve includes a nozzle via which liquid water may be ejected into the lower chamber under pressure, wherein as liquid water is passed through the nozzle, under pressure, it may vaporize. Typically, the water vapor injected into the lower chamber is at a temperature of around 90 degrees centigrade.

Preferably, the second inlet valve includes a controller adapted to control the opening and closing of the second inlet valve. Typically, the controller may include an electronic controller and more typically, the partition controller may also serve as the controller for the second inlet valve.

Preferably, the Hydrogen may be produced by the process of electrolysis. For instance, the present invention may typically include a container having a supply of water stored therein. Preferably, the container may include a glass material. Preferably, a cathode and an anode connected to negative and positive terminals of a power supply (e.g. a regular 12 volt car battery) respectively may each be inserted into the water within the container to allow an electric current to pass through the water thereby causing Hydrogen gas to form at the cathode and oxygen from the water to form at the anode. Preferably, the second conduit may be connected to the container to allow for the Hydrogen that is formed to be supplied into the lower chamber of the cylinder.

Preferably the present invention may also include an exhaust valve. Typically the exhaust valve may be attached to the gasket and may allow fluid to be evacuated from the upper chamber. Preferably, the exhaust valve includes a controller adapted to control the opening and closing of the exhaust valve. Typically, the controller may include an electronic controller and more typically, the partition controller may also serve as the controller for the exhaust valve.

Typically, the exhaust valve may remain closed at all times until after step (iv) is commenced. Typically, the exhaust valve may be opened when water vapor has ceased expanding. Typically, the present invention may include a sensor disposed within the lower chamber which may be adapted to detect when water vapor has substantially ceased expanding. An output of the sensor may serve as a trigger for opening the exhaust valve. For instance, the output of the sensor may be interfaced with the exhaust valve controller, wherein the exhaust valve controller may be configured to automatically open the exhaust valve when the output of the sensor indicates that water vapor has substantially ceased expanding. Typically, water vapor may substantially cease expanding when the piston is less than half-way through the completion of the second downstroke. Preferably, the exhaust valve may be closed when the piston has completed its second upstroke such that the piston engine may be ready to progress through the cycle of steps (i) to (iv) of the first broad form once again.

Typically, as the second upstroke is being effected, the exhausted water vapor may condense and may be evacuated via the exhaust valve and recirculated to the second supply means for re-use. Alternatively, at least some of the re-condensed water may be circulated around the engine to also serve as a coolant.

Typically, in performing step (ii) of the first broad form, the air may be compressed into the upper chamber such that it is heated to at least about 500 degrees centigrade. Preferably, the step of compressing the air into the upper chamber may be conducted relatively rapidly and may involve a compression ratio of at least about 16:21. In certain embodiments, a heating element may also be disposed in the upper chamber to further assist in increasing the temperature of the compressed air stored therein. The heating element may include a resistance wire having a current passed through it. Typically the heating element may be mounted to the gasket so as to extend inwardly of the upper chamber, and, the current may be provided via a 12-volt battery such as those used in standard vehicle.

Preferably, the present invention includes a means of thermally insulating the engine. For instance, this may include a thermal casing adapted to enclose the chamber.

Typically, the piston engine which is used to perform the steps of the present invention may be formed by modifying a common petrol or diesel piston engine. The common petrol or diesel piston engine typically does not have a partition within the cylinder and/or a partition valve which is attached to the gasket as hereinbefore described. Instead, the prior art piston and cylinder cooperatively define a single chamber and may have a fuel injector disposed on the gasket. Typically, in retro-fitting the petrol or diesel engine, at least one of the following steps may be performed:

(A) a gasket of the piston engine may be removed to enable fitting of a partition into the cylinder;

(B) a length of the piston may be adjusted to increase the compression ratio that may be obtained from use of the piston-cylinder;

(C) a partition as hereinbefore described may be installed within the cylinder to form an upper and lower chamber;

(D) a partition valve may be installed as hereinbefore described in order to control fluid communication between the upper and lower chambers.

Preferably, in step (C) the partition may be selectively installed at a position within the cylinder such that when the piston has been retracted inwardly of the cylinder as far as possible, an inward-facing surface of the piston may abut substantially flush against the partition. Advantageously, this step may assist in reducing if not substantially eliminating a gap between the piston and the partition so that the degree of compression of the air into the upper chamber may be improved. In contrast, with certain prior art inventions, such as that described in PCT/AU2005/000770, when the piston is retracted into the cylinder, a substantial gap may remain between the receptacle (in which air is forcibly compressed in to by the piston) and therefore, optimal compression of the air may not be achieved.

It would be appreciated by a person skilled in the art that the positioning of the partition during retro-fitting of a petrol or diesel engine need not necessarily result in the piston being able to abut exactly flush against the partition when the piston is fully retracted into the cylinder. However, it would be appreciated by a person skilled in the art that an advantage may be obtained in at least positioning the partition so that as small a gap as possible exists between the partition and the inward-facing surface of the piston.

Typically, a gasket of an unmodified petrol or diesel engine may have a fuel injector disposed in it and in retro-fitting the petrol or diesel engine, the injector may typically be removed and the mounting member of the partition valve may be installed in its place.

In a second broad form, the present invention provides a piston engine as described in accordance with the first broad form of the present invention.

In a third broad form, the present invention provides a method of modifying a petrol and/or diesel engine as described in accordance with the first broad form of the present invention.

In a fourth broad form, the present invention provides a partition as described in accordance with the first broad form of the present invention.

In a fifth broad form, the present invention provides a partition valve as described in accordance with the first broad form of the present invention.

In a sixth broad form, the present invention provides a kit including:
a partition; and
a partition valve;

wherein the partition and partition valve are adapted for installation on a diesel and or petrol engine to provide a piston engine as described in accordance with the first broad form of the present invention.

### BRIEF DESCRIPTION OF THE DRAWINGS

The present invention will become more fully understood from the following detailed description of a preferred but non-limiting embodiment thereof, described in connection with the accompanying drawings, wherein:

FIG. 1 depicts a prior art diesel engine;

FIG. 2 depicts a first embodiment piston engine in use during a first operating cycle;

FIG. 3 depicts a first embodiment piston engine ins use during a second operating cycle;

FIG. 4 depicts a first embodiment piston engine in use during a third operating cycle;

FIG. 5 depicts a first embodiment piston engine in use during a fourth operating cycle;

FIG. 6 depicts a top partially transparent view of a partition in stand-alone fashion, which is adapted for insertion in the cylinder;

FIG. 7 depicts a side view of a partition valve in stand-alone fashion.

### DETAILED DESCRIPTION OF THE PREFERRED EMBODIMENT

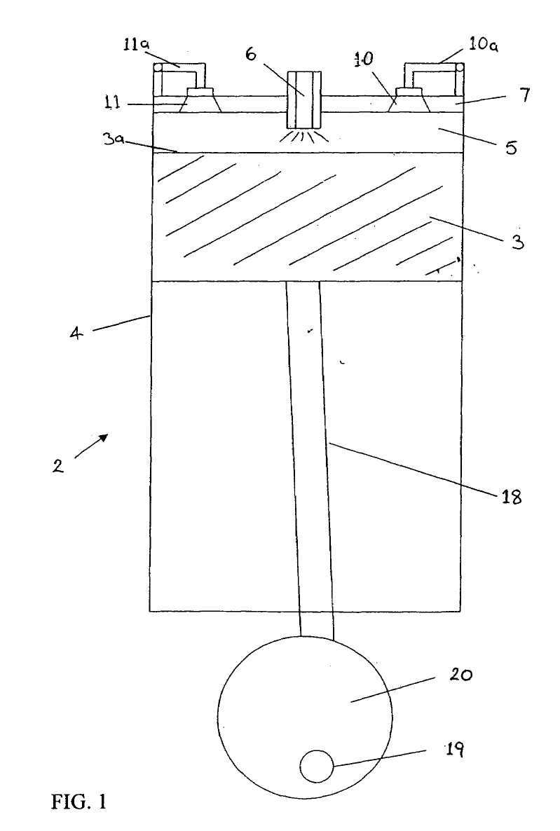

The first embodiment piston (1) engine is formed by modifying a prior art diesel engine (2) as depicted in FIG. 1. The prior art diesel engine (2) includes a piston (3) and cylinder (4) which cooperatively define a single cylinder chamber (5) of variable volume. For simplicity, FIG. 1 depicts only those features of the prior art diesel engine which are relevant to explaining the implementation of the first embodiment, but it would be appreciated by a person skilled in the art that other embodiments may also includes other features that need not be described herein.

FIG. 1 shows the diesel engine (2) with the piston (3) retracted to its full extent into the cylinder (4). As can be seen, when the piston (3) is retracted to its limit within the cylinder (4), a substantial gap exists between the gasket (7) and a top surface of the piston (3).

The diesel engine (2) also includes a fuel injector (6) mounted on the gasket (7), an exhaust valve (10) and a first inlet valve (11) on each side of the fuel injector (6).

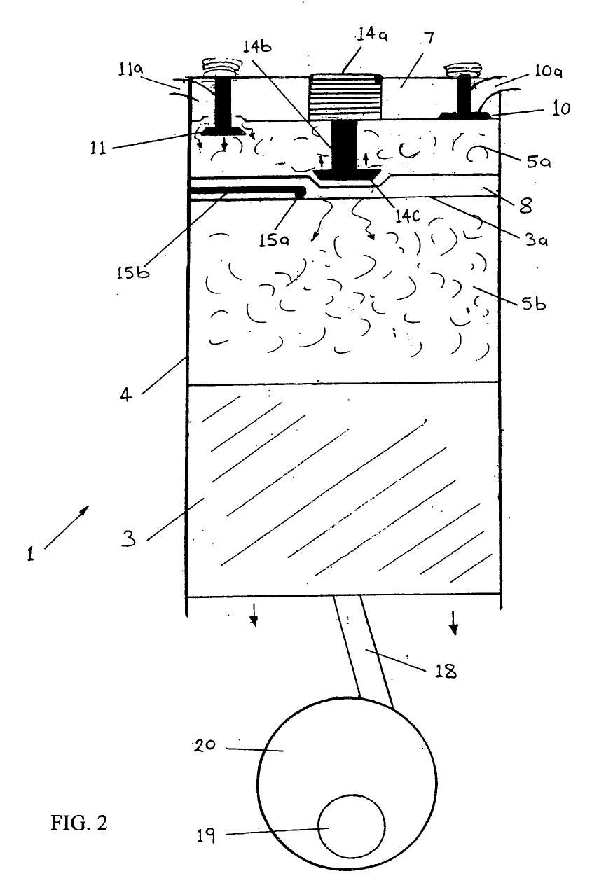

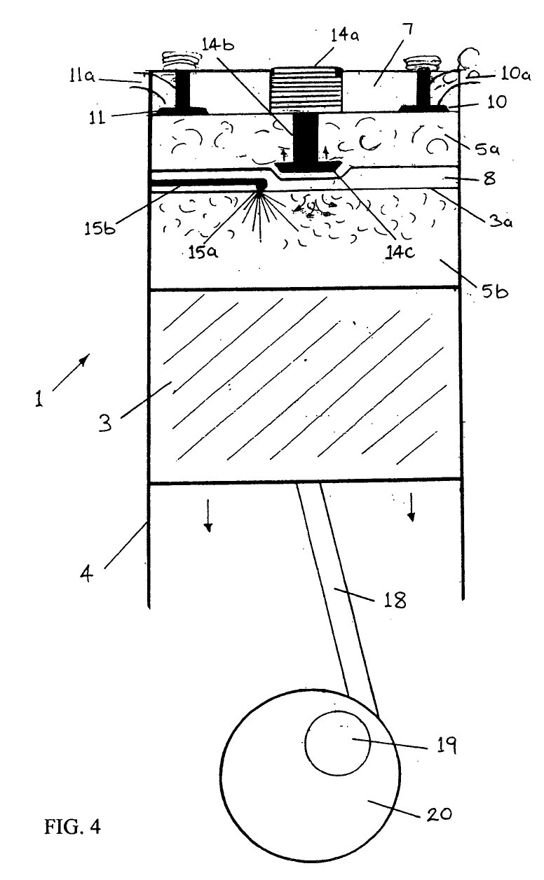

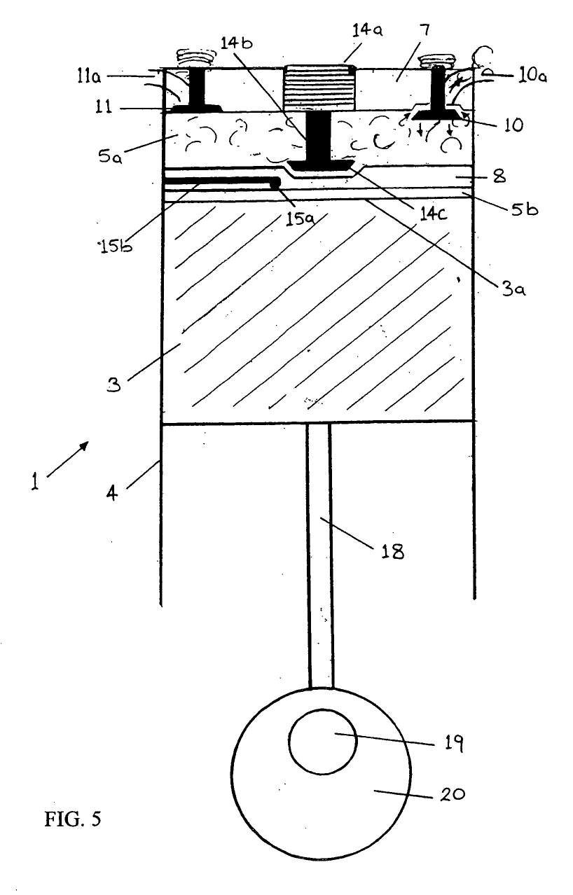

Turning now to FIGS. 2 to 7, in forming the first embodiment piston engine (1), the prior art diesel engine (2) is modified by firstly removing the gasket (7) and fitting a partition (8) into the cylinder (4) so as to form an upper and lower chamber (5a,5b) within the cylinder (4).

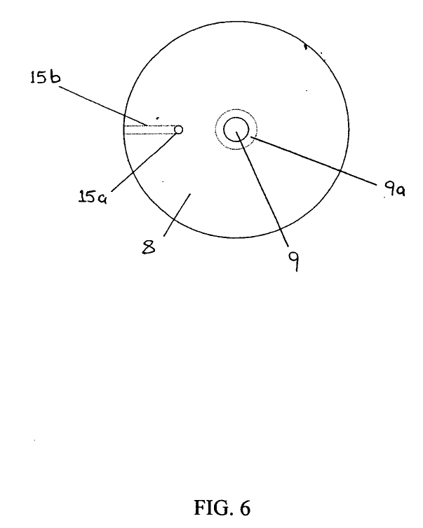

The partition (8) includes a metal plate having a shape characteristic adapted to complement the cross-sectional shape of the cylinder (4) and has a thickness of around 10 mm. The partition (8) is welded into place within the cylinder (4). FIG. 6 depicts a top view of a partition (8) as used in the first embodiment, in stand-alone fashion.

The partition (8) includes a partition opening (9) so as to enable fluid communication between the upper and lower chambers (5a,5b) in the cylinder (4). The partition opening (9) is located substantially at a central position on the partition (8). The partition (8) includes a partition recess (9a) disposed around the periphery of the partition opening (9).

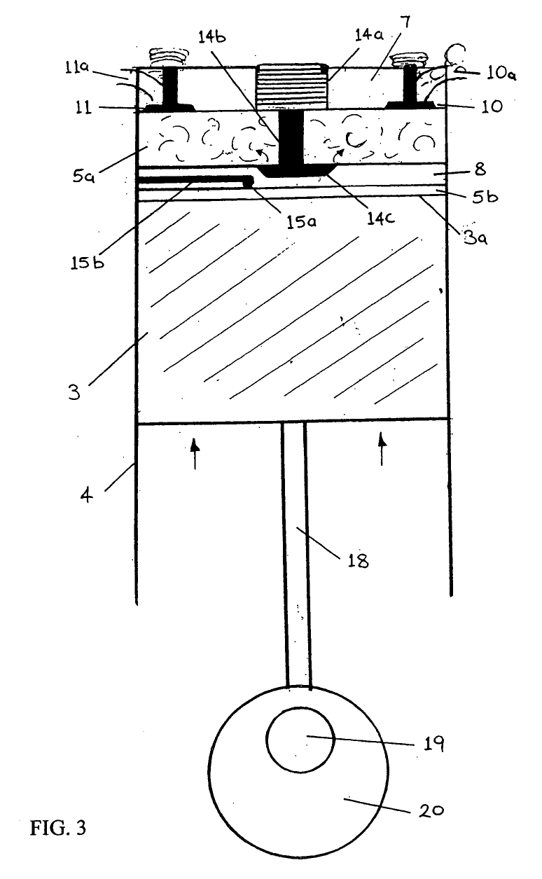

The partition (8) is installed within the cylinder (4) in a position such that when the piston has been retracted inwardly of the cylinder (4) as far as possible, an inward-facing surface (3a) of the piston (3) will abut substantially flush against the partition (8) to assist in optimally compressing air into the upper chamber (5b) when the piston (3) is fully retracted. This is depicted for instance in FIG. 3.

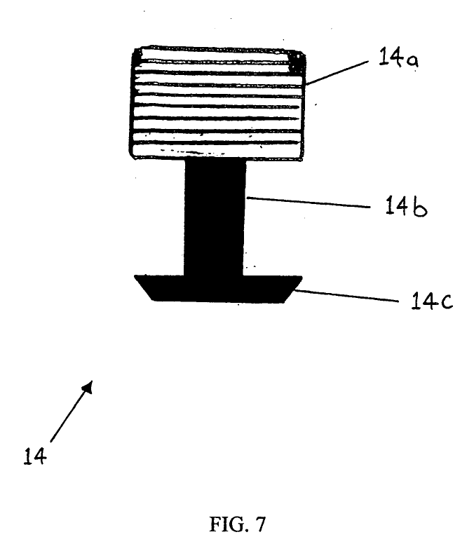

The next step in modifying the prior art diesel engine (2) requires the removal of the fuel injector (6) from the gasket (7) and replacing the fuel injector (6) with a partition valve (14). FIG. 7 shows a partition valve (14) which is used in the first embodiment, in stand-alone fashion.

When the fuel injector (6) is removed, an aperture remains in the gasket (7) which passes right through the gasket (7). The partition valve (14) includes a mounting member (14a) adapted for screw-threaded engagement with the aperture in the gasket, an elongate portion (14b) having a first end attached to the mounting member (14a), and, a second end attached to a valve seal (14c). The mounting member (14a) of the partition valve (14) is attached to the gasket (7) such that the elongate portion (14b) extends inwardly of the upper chamber (5a) towards the partition (8).

The elongate portion (14b) is adjustably extendable and retractable relative to the mounting member (14a) such that when the elongate portion (14b) is extended relative to the mounting member (14a), the valve seal (14c) is positioned to cover the partition opening (9) so as to restrict fluid communication between the upper and lower chambers (5a,5b). This is shown for instance in FIGS. 2, 4 and 5. Furthermore, when the valve seal (14c) is positioned to cover the partition opening (9), the valve seal (14c) is snugly received within the recess (9a) surrounding the partition opening (9).

When the elongate portion (14b) is retracted relative to the mounting member (14a), the valve seal (14c) is positioned such that it does not cover the partition opening (9) so that fluid communication is enabled between the upper and lower chambers (5a,5b) via the partition opening (9).

The partition valve (14) is electrically actuated between opened and closed positions by use of a microprocessor (not shown) which is housed within the mounting member (14a).

Substantially water-free air is able to be channeled to the first inlet valve (11) via a first conduit (11a) for release into the upper chamber (5a). The first inlet valve (11) is attached to the gasket (7).

The first embodiment also includes a second inlet valve (15a) and a second conduit (15b) adapted to allow water and Hydrogen to be channeled to the second inlet valve (15a) for release into the lower chamber (5b) from a water and Hydrogen supply source. The second inlet valve (15a) and the second conduit (15b) are housed within a hollow interior of the partition (8).

As the water passes through the second inlet valve (15a) under pressure, water vapor is able to be formed in the lower chamber (5b). The water vapor is supplied into the lower chamber (5b) at a temperature of around 90 degrees centigrade.

Hydrogen is also able to be supplied into the lower chamber (5b) via the second inlet valve (15a). The Hydrogen is produced by the process of electrolysis. The first embodiment includes a glass container (not shown) disposed adjacent the cylinder (4) wherein the glass container has a supply of water stored therein. A cathode and an anode connected to negative and positive terminals of a power supply (e.g. a regular 12 volt car battery) respectively, each are inserted into the water within the container to allow an electric current to pass through the water thereby causing Hydrogen gas to form at the cathode and oxygen from the water to form at the anode. The second conduit (15b) is connected to the glass container to allow for the Hydrogen that is formed to be supplied into the lower chamber (5b) of the cylinder (4).

In this embodiment, for convenience, the exhaust valve (10), first inlet valve (11) and second inlet valve (15a) are electronically controlled by the partition valve controller (17).

In use, a connecting rod (18) extends from the piston (3) and is operably connected to a crankshaft (19) via a cam profile (20). Inward and outward movement of the piston (3) relative to the lower chamber (5b) of the cylinder (4) causes the cam profile (20) to rotate. In turn, rotation of the cam profile (20) causes the piston (3) to be cyclically retracted into and extended-outwardly of the lower chamber (5b) of the cylinder (4).

A method of using the first embodiment will now be described as follows.

The piston (3) is initially retracted inwardly of the lower chamber (5b) so that it abuts substantially flush against the partition (8). To commence operation of the first embodiment, a user will normally manually rotate the cam profile (20) so that the piston (3) initiates its first downstroke relative to the lower chamber (5b).

At substantially the same time that the first downstroke commences, the first inlet valve (11) and the partition valve (14) are both opened up. Substantially water-free air is able to flow into the upper chamber (5a) and lower chamber (5b) of the cylinder (4).

The first downstroke of the piston (3) relative to the lower chamber (5b) causes a vacuum to form within the cylinder (4) and the vacuum draws the air into the upper and lower chambers (5a,5b) via the first inlet valve (11).

Upon completion of the first downstroke, rotational motion of the cam profile (20) and momentum of the piston (3) causes the piston (3) to be again re-directed inwardly of the lower chamber (5b) in a first upstroke. As the piston (3) is commencing its first upstroke, the first inlet valve (11) is automatically closed by a controller which is also provided by the partition valve controller (17), and the partition valve (14) remains opened so that the air in the upper and/or lower chambers (5a,5b) is able to be compressed into the upper chamber (5b).

During its first upstroke, the piston (3) should rapidly compress the air into the upper chamber (5a) to a ratio of at least about 16:21. The rapidly compressed air attains a temperature of at least about 500 degrees centigrade. In this embodiment, a heating element (not shown) is also disposed within the upper chamber (5a) to assist in increasing the temperature of the compressed air stored therein to at least about 500 degrees centigrade. The heating element includes a resistance wire which is connected via a switch to a power supply (not shown) so that current can be passed through it so as to heat up the wire. The heating element is mounted to the gasket (7) so that is can extend inwardly of the upper chamber (5a) in use.

When the piston (3) has completed its first upstroke, the piston (3) should abut substantially flush against the partition (8). Also at the completion of the first upstroke, the partition valve (14) is automatically closed so as to ensure that the compressed air is temporarily retained inside the upper chamber (5a) for later release. The triggering of the closure of the partition valve (14) can be effected by using a position sensor (22) to detect when the piston (3) is substantially abutting against the partition (8) which would indicate that the piston (3) has compressed the air into the upper chamber (5a) as far as is possible.

Thereafter, the piston (3) commences a second downstroke as a result of momentum of the piston (3) being directed out of the cylinder (4) due to the interaction with the cam profile (20). Almost instantaneously after the piston (3) commences the second downstroke, water vapor and Hydrogen is supplied into the lower chamber (5b) via the second inlet valve (15a). Approximately 3 cubic centimeters of water should be supplied into the lower chamber (5b) to fill every one liter vacuum of the lower chamber (5b) as the piston (3) is moving through its second downstroke.

The partition valve (14) is opened approximately 10 milliseconds after the water vapor and Hydrogen have been supplied into the lower chamber (5b). Upon opening of the partition valve (14), the water vapor and Hydrogen in the lower chamber (5b) is caused to expand upon interaction with the heated air so as to force outward movement of the piston (3) from the cylinder (4). The expansion of the water and hydrogen forces the piston (3) through a second downstroke.

The exhaust valve (10) remains closed at all times until water vapor has ceased expanding during the second downstroke. When it is detected that water vapor has ceased expanding, the exhaust valve (10) is automatically opened up to allow waste fluid to be evacuated from the upper chamber (5a). The water will normally cease expanding when the piston (3) is less than halfway through its second downstroke.

A sensor (23) is disposed within the lower chamber (5b) which is used to detect when water vapor has substantially ceased expanding. An output of the sensor (23) serves as a trigger for opening the exhaust valve (10).

As the second upstroke is being effected, the exhausted water vapor condenses and is able to be evacuated via the exhaust valve (10) and recirculated for re-use.

Those skilled in the art will appreciate that the invention described herein is susceptible to variations and modifications other than those specifically described without departing from the scope of the invention. All such variations and modification which become apparent to persons skilled in the art, should be considered to fall within the spirit and scope of the invention as broadly hereinbefore described. It is to be understood that the invention includes all such variations and modifications. The invention also includes all of the steps and features, referred or indicated in the specification, individually or collectively, and any and all combinations of any two or more of said steps or features.

The reference to any prior art in this specification is not, and should not be taken as, an acknowledgment or any form of suggestion that that prior art forms part of the common general knowledge.

What is claimed is:

1. A method for use in controllably generating mechanical power from a piston engine without combusting fuel, wherein the piston engine includes:
a piston;
a cylinder having an upper chamber and a lower chamber separated by a partition, the partition including an opening and a partition valve located adjacent the opening, the partition valve being adjustable between an opened and a closed position, wherein when the valve is arranged in the opened position, fluid communication via the opening is enabled between the upper and lower chambers, and when the partition valve is arranged in the closed position, fluid communication between the upper and lower chambers via the opening is substantially restricted;
the piston being slidably engagable within the cylinder between a lower end of the cylinder and the partition so as to be able to vary a volume of the lower chamber between a relative minimum volume, and, a relative maximum volume;
the upper chamber being bounded by the partition and a gasket disposed on an upper end of the cylinder;
a first supply adapted for supplying air in to at least one of the upper and lower chambers; and
a second supply adapted for supplying at least one of water vapor and Hydrogen in to the lower chamber;
the method including the steps of:
(i) supplying air into at least one of the upper and lower chambers via the first supply;
(ii) thereafter, compressing the air into the upper chamber so as to form heated air, and closing the partition valve so as to temporarily store the heated air within the upper chamber;
(iii) thereafter, supplying at least one of water vapor and Hydrogen into the lower chamber via the second supply;
(iv) thereafter, opening the partition valve when the lower chamber is at a relative minimum volume wherein, the heated air disposed in the upper chamber is released into the lower chamber via the opened partition valve, and the water vapor and/or Hydrogen in the lower chamber is caused to expand upon interaction with the heated air so as to force outward movement of the piston from the cylinder, whereby the lower chamber is adjusted from the relative minimum volume into the relative maximum volume.

2. A method as claimed in claim 1 wherein step (i) includes the sub-steps of:
(a) opening the first supply;
(b) opening the partition valve; and
(c) effecting a first downstroke of the piston relative to the lower chamber wherein the volume of the lower chamber is adjusted from the relative minimum volume into the relative maximum volume.

3. A method as claimed in claim 1 wherein step (ii) includes the sub-steps of:
(a) closing the first supply means;
(b) effecting a first upstroke of the piston relative to the lower chamber wherein the lower chamber is adjusted into the relative minimum volume from the relative maximum volume so as to forcibly compress the air into the upper chamber; and
(c) thereafter, closing the partition valve when the lower chamber has been adjusted into the relative minimum volume so that the air compressed into the upper chamber is releasably held within the upper chamber.

4. A method as claimed in claim 1 including the step of providing the partition valve with:
a mounting member adapted for coupling the partition valve to the cylinder; and
an elongate portion having a first end attached to the mounting member, and, a second end attached to a valve seal, the elongate portion being adjustably extendable and retractable relative to the mounting member wherein, when the elongate member is extended relative to the mounting member the valve seal is positioned to cover the partition opening so as to restrict fluid communication between the upper and lower chambers, and, when the elongate portion is retracted relative to the mounting member, the valve seal is positioned such that it does not cover the partition opening so that fluid communication is enabled between the upper and lower chambers via the partition opening.

5. A method as claimed in claim 1 including the step of providing a partition recess disposed around a periphery of the partition opening such that when the valve seal is positioned in the closed position relative to the partition opening, the valve seal is able to be received within the recess.

6. A method as claimed in claim 1 including the step of releasably mounting the mounting member of the partition valve to the gasket wherein the elongate portion extends inwardly of the upper chamber towards the partition.

7. A method as claimed in claim 6 including the step of mounting the mounting member of the partition valve to the gasket by screw-threaded engagement with an aperture disposed in the gasket.

8. A method as claimed in claim 7 wherein the aperture extends through the gasket such that the partition valve is able to be removed from the cylinder via the aperture in the gasket without removing the gasket from the cylinder.

9. A method as claimed in claim 1 including the step of providing an electronic valve controller adapted for electronically actuating the partition valve into the opened and closed positions.

10. A method as claimed in claim 9 wherein the electronic valve controller is housed within the mounting member.

11. A method as claimed in claim 1 wherein in step (i) the air supplied into the upper chamber via the first supply means includes substantially water-free air.

12. A method as claimed in claim 1 wherein in step (ii) when the air is compressed into the upper chamber to form heated air, the heated air attains a temperature of at least about 500 degrees centigrade.

13. A method as claimed in claim 1 wherein in step (iii) the Hydrogen that is supplied into the lower chamber is produced by applying electrolysis to a supply of water.

14. A method as claimed in claim 1 including the further step of providing an exhaust valve adapted for evacuating at least one of water, Hydrogen, and air from the upper chamber.

15. A method as claimed in claim 14 including the step of opening the exhaust valve after step (iv) commences.

16. A method as claimed in claim 14 including the step of opening the exhaust valve when water vapor within the lower chamber has substantially ceased expanding during step (iv).

17. A piston engine configured to perform the method steps in accordance with claim 1.

18. A partition configured for use in performing the method steps in accordance with claim 1.

19. A partition valve configured for use in performing the method steps in accordance with claim 1.
